(19) United States
(12) Patent Application Publication
(10) Pub. No.: US 2010/0013183 A1
(43) Pub. Date: Jan. 21, 2010

(54) Three wheeled scooter

(76) Inventor: Rurong He, Duluth, GA (US)

Correspondence Address: Roderic N. Uphaus, 103 Dendron Av., Troy, AL, 36081, US

(21) Appl. No.: 12/218,725

(22) Filed: Jul. 18, 2008

(51) Int. Cl. B62M 1/00; B62D 61/06; B62J 39/00; B60G 9/00

(52) U.S. Cl. 280/210; 180/210; 280/288.4; 280/124.1

(57) ABSTRACT

A new and improved stand up type scooter used for traveling across generally flat terrain such as asphalt or concrete. The invention comprises of a three-wheeled scooter manually, gas, or electrically powered. The scooter consists of a frame, floor deck, steering tee handle, pivoting front suspension, two front wheels for added traction, and one rear powered or non-powered wheel. The invention incorporates a center stand for upright storage and a foldable handle for compact transport of the mechanism. Optional quick attach seat system for riding in seated position.

### BACKGROUND OF THE INVENTION

1. Field of the Invention

The present invention relates to the field of outdoor recreation products. More particularly, the invention relates to electric or gasoline ride on scooters which are used both for recreation and for transportation. The present invention is generally operated on paved or hard surfaces such as asphalt or concrete. The present invention has three wheels that contact the pavement, a platform to stand on which houses the powered drive system, and a foldable and extendible steering handle with controls.

2. General Background of the Invention

Children and adults alike often employ commercially available powered and non-powered ride on scooters that enable them to travel from location to location on generally horizontal terrain with very little effort. A popular source for powered ride on scooters is Pep Boys of Philadelphia Pa.
Web site: www.pepboys.com.
   Independent motorcycle, ATV, and go kart dealers are also typical points of purchase of this style of product.

Inherent traction issues are present with any two wheeled ride on products i.e. Scooters, motorcycles, and alike. Obstacles such as gravel, bumps, holes and debris on the surface being traveled on can cause loss of traction allowing the wheels to slip possibly resulting in loss of control which could cause an accident. The front steering and or leading wheel are the most critical for maintaining control because they guide the entire mechanism. Therefore it is favorable to introduce a second wheel to the front or leading member to enhance traction and control.

### BRIEF SUMMARY OF THE INVENTION

The present invention provides an elevated rate of stability not found in the common two wheeled vehicles. Introduction of the third wheel and tire assembly, or more specifically two tires and wheel assembles parallel to each other on the front steering, increases the traction abilities of the entire machine. The addition of a spring loaded front suspension allows the scooter to lean and turn much like two wheeled scooters. The front suspension also allows the tires to bounce independently from one another over obstacles present on the surface being traveled. This increases the tire contact on the surface providing a safer environment.

The present invention employs an electric powered drive system not uncommon to other scooters of similar style. This powered drive system consists of batteries, motor controller, motor, chain, sprockets and rear powered drive wheel. The invention also employs a common brake system which is affixed to the rear wheel assembly.

The above mentioned drive system and braking system are housed within a frame. Provided within a recessed portion of that frame is a top deck on which the operator stands to operate the scooter. Incorporated on the forward neck of that frame is the control panel consisting of the ON-OFF switch, an electrical breaker and a means of charging the batteries.

Located at the furthest point forward on the neck of the frame is a generally vertical tube. Located within upper and lower portions of this open tube are ball bearing sets that allow the mounting of the front suspension containing the wheels, springs and pivoting mechanism to the main frame thru the above mentioned tube. The ball bearing sets allow the free rotation of the mounted suspension for steering within the frame as the mechanism is in use.

The upper most portion of the mounted suspension employs an affixed portion of a pivoting joint for the mounting of the extendible steering handle. This pivoting joint is used as a means of folding the steering handle for transport or storage. A second member of the pivoting joint is rotateabley affixed with a pen to the pivoting member on the mounted suspension. With in that second member is a tube that follows inside the length of the upper most part of the pivot. Along the forward most portion of the tube is a slot. Placed within this tube is a round sliding threaded nut which is used to retain the upper portions of the steering tube and handle.

The steering tube and handle is placed over the protruding portion of the upper most part of the pivoting member. A tee style thumb bolt is positioned thru the upper most hole of the two holes provided in the side of the steering tube and into the sliding nut located with in the pivot tube. When the steering handle is lifted into the vertical operational position, it is then slid downward over the entire pivoting joint. A second thumb style bolt is placed into the lower hole thru the steering tube and tightened into the lower portion of the upper pivoting member. This forces the inside of the outer tube to bind with the pivoting joint creating a solid joint between the two. The upper thumb bolt is then also tightened with in the sliding nut to increase the strength of the joint.

An extendible steering tube is provided for easy operator height adjustment. This extendible steering tube and handle are oval shape to prevent rotation within one another during use. A leaver style clamp is provided on the outside of the oval style tubing. When released this clamp allows the outer tube to relax as the inner tube is moved up or down within the outer tube, then the outer tube can be clamped to the inner tube preventing movement during use. A sleeve bushing is provided inside the outer steering tube, and a stop sleeve is provided on the inner tube to allow free up and down movement of the tubes between themselves. This also provides a fixed stop on the tubes to prevent accidental separation of the tubes.

The upper steering handle incorporates the necessary controls. The twist throttle and the manual brake leaver are on the steering handle. The electronic controller eliminates the possibility of accelerating and braking at the same time, which prevent damage to the entire drive system.

A center stand provides a means of supporting the scooter when not in use. This stand lowers and supports the rear of the scooter stabilizing it from falling over. This stand automatically retracts when in use. This center stand is electronically interfaced with the controller to prevent free standing revving of the drive system and inadvertent damage to the system by high RPM engagement of the rear tire.

A quick attachment seat accessory allows the operator to sit while riding the scooter or quickly remove the seat from simple fasteners, if stand up riding only is desired.

### BRIEF DESCRIPTION OF THE DRAWINGS

For a further understanding of the nature, objects, and advantage of the present invention, reference should be given to the following drawings, read in conjunction with the following detailed description, wherein like reference numerals denote like elements:

FIG. 1 is a right side perspective illustration of the invention as positioned in a stored position with center stand down.

FIG. 2 is a frontal right view illustrating the front suspension engaged in a right turn.

FIG. 3 is an operator's prospective view of front suspension looking downward over tee steering handle and controls.

FIG. 4 is a front prospective view of the front suspension and rear deck and frame of the invention.

FIG. 5 is a front view of the front suspension separate from the chassis.

FIG. 6 is an exploded view of the front suspension separate from the chassis.

FIG. 7 is a front left side view of the suspension and folded steering controls.

FIG. 8 is a front left side view of the suspension and the folded handle, separated from the handle pivot showing a separated view of the position of the sliding nut.

FIG. 9 is a left side prospective view of the invention with the steering shaft folded for storage or transport.

FIG. 10 is an upper right side prospective view of the scooter with the optional quick attachment seat. It is also depicted with the seat assembly separated.

### DETAILED DESCRIPTION OF THE INVENTION

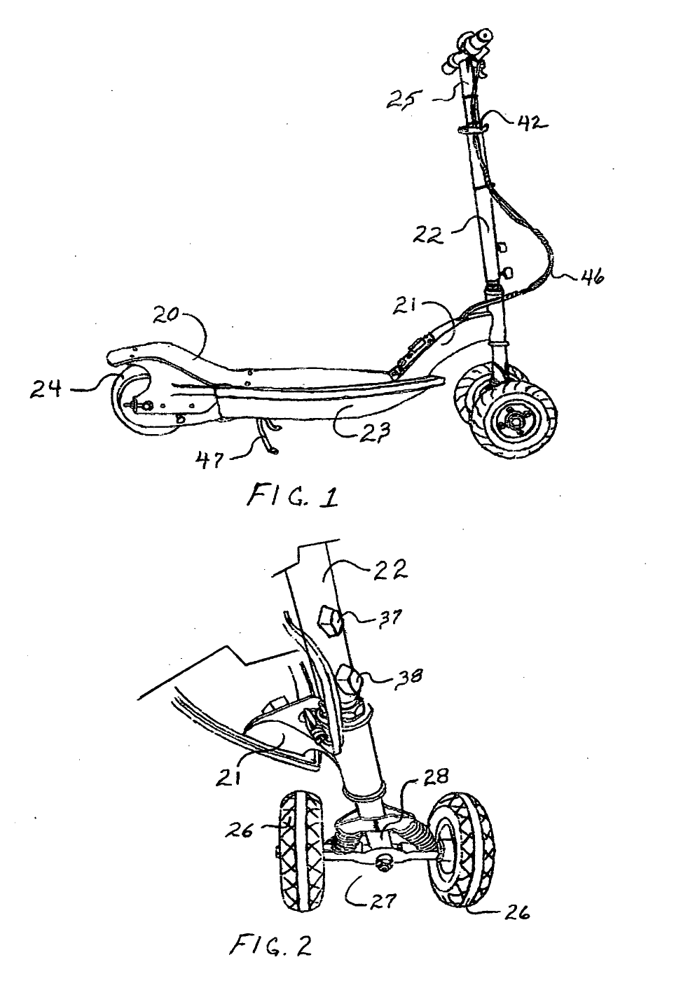

To best describe the present invention attention should be given to FIG. 1. The overall right side prospective view of the complete invention with steering tubes comprising of 22 Lower Steering tube and 25 Upper tee steering tube in the upright operating steering position.

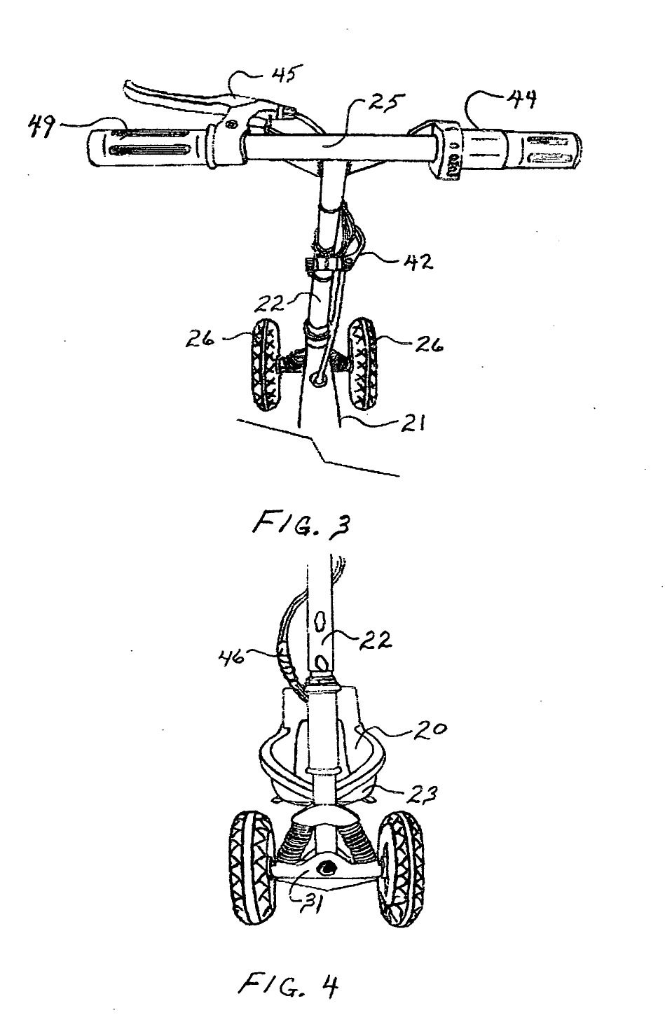

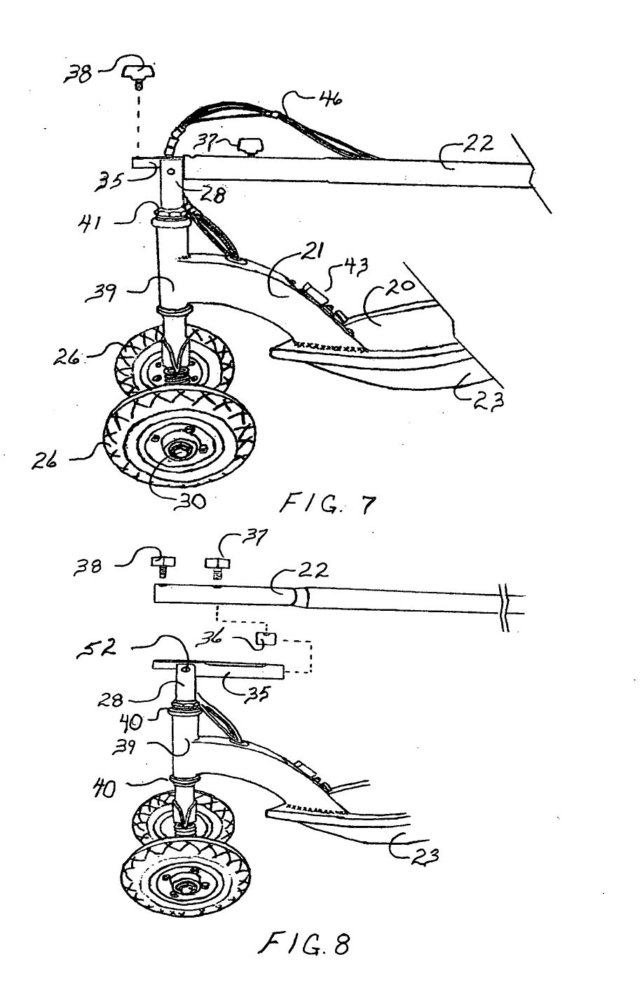

Operator (Not Shown) energizes on/off switch of 43 switch panel FIGS. 7 and 9. Operator then stands on floor deck 20 of FIGS. 1, 4 7 and 9. Holding 44 twist throttle assembly and 49 handle grip of FIG. 3 witch are affixed to 25 upper tee steering tube. The operator manually urges the mechanism in the direction of the 26 two front tire and wheel assemblies of FIGS. 2, 3, 5, 7 and 6. This forward movement urges 47 center stand FIGS. 1 and 9 to retract into upward horizontal operating position. This retracted operating position of 47 center stand allows an electrical circuit to be completed energizing the 44 twist throttle. The operator twists 44 twist throttle (of common art) to energize the controller (of common art) housed above 23 bottom cover of FIGS. 1, 4, 7, 8 and 9 and below 20 floor deck. This said controller directs electrical power from the batteries (of common art) housed above 23 bottom cover and below 20 floor deck, to the drive motor 48 of FIG. 9. Thru sprockets and roller chain (of common art) the energy is transmitted to 24 rear drive wheel FIGS. 1 and 9. The rear drive wheel 24 urges the mechanism forward at speeds of 12 to 15 miles per hour transporting the operator.

The complete mechanism of FIGS. 1 and 9 is halted by applying pressure to 45 brake leaver of FIG. 3. The 45 brake leaver transmits a pulling force thru 46 brake and throttle cable harness, simultaneously a micro switch molded within the 45 brake leaver breaks a circuit to the controller, stopping the transmit of power to the 48 electric motor. The (common art) 50 brake band assembly of FIG. 9 is energized at the 24 rear drive wheel by the brake cable thus stopping the rotation of 24 rear drive wheel halting the forward motion of the mechanism and operator.

Steering of the mechanism is executed by the changing operator balance (or leaning) from the left or right side and the rotation of 25 upper tee steering tube of FIGS. 1, 3 and 9 into the desired direction of turn. To better describe the steering tube arrangement, oval shaped upper tee steering tube 25 engages oval shaped larger diameter 22 lower steering tube at a location above 42 steering tube adjusting clamp. On a completed assembly, a bushing is placed inside the lower steering tube near the location of 42 steering tube adjustment clamp. Lower steering tube bushing 51 is an oval shaped bushing with an upper lip to allow proper assembly location. 51 steering bushing is pressed and retained in 22 lower steering tube, by fasteners not shown. Before lower steering bushing 51 is pressed into lower tube 22, it is placed onto 25 upper tee steering tube along the portion that enters into lower tube 22. A second plastic sleeve bearing is placed and retained on the far most oval location of the 25 upper tee handle. This said bushing enters 22 lower steering tube and is retained from extraction by retainers affixing 51 lower steering bushing to 22 lower steering tube. This combination of 25 upper steering tube and lower 22 steering tube and bushings produce an adjustable length steering tube that will not separate and can be clamped at the desired height by 42 steering tube adjustable clamp.

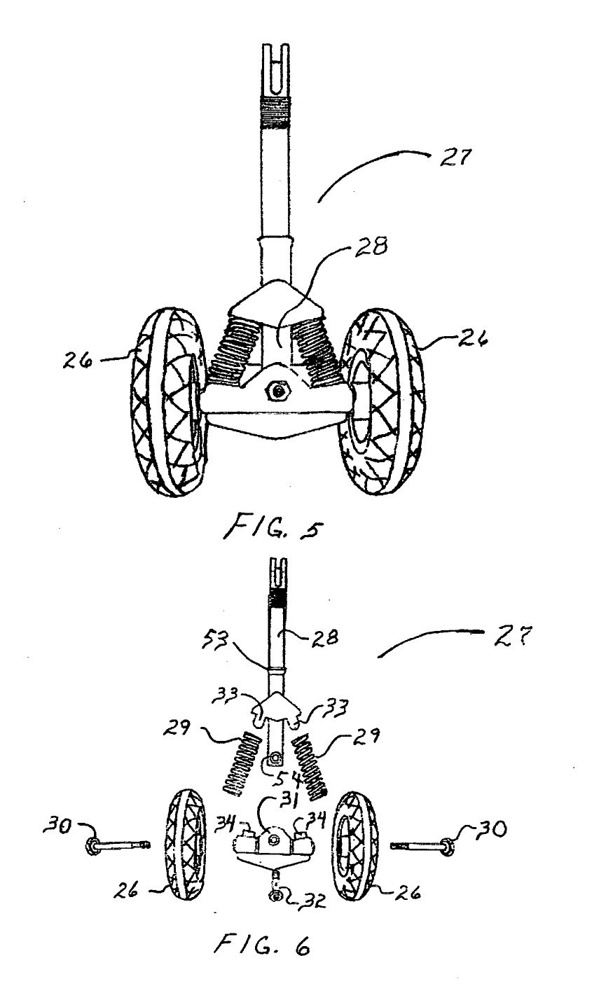

To further explain the steering apparatus of the preferred embodiment of the invention attention should be given to 35 upper steering shaft pivot of FIGS. 7 and 8 and 28 pivoting steering shaft of FIGS. 6, 7 and 8 and 52 pivot pen of FIGS. 8 and 9. It should be understood that 28 pivoting steering shaft, 35 upper steering shaft pivot and 52 pivot pen are joined together to form a foldable steering pivot joint at pen location 52 on FIGS. 8 and 9.

It should be noted that the foldable pivot joint allows the upper steering tube 25 and the lower steering tube 22 to pivot as an assembly in one direction only. This direction is to the rear of the mechanism as depicted on FIG. 9.
Best depicted on FIG. 8, it should be noted that 35 upper steering shaft pivot incorporates a hollow portion extending generally rearward from the pivot pen 52 location. This hollow area employs a slot extending nearly its length of the hollow area.
36 sliding lock nut sleeve is located within the hollow area and positioned so that the threaded position of 37 lock sleeve tee bolt will enter into the threaded portion of the lock sleeve nut when 37 lock sleeve tee nut is positioned thru the upper hole shown in position on FIG. 7 and tightened into 36 sliding lock nut.

To place the steering shaft assembly in operational upright position as depicted on FIG. 1, the 25 tee handle and 22 lower steering tube are raised into an upright position simultaneously, pivoting 35 upper steering shaft pivot. After the handle is in the upright position, it is urged downward over the exposed portion of the 28 pivoting steering shaft, as it moves downward 36 sliding lock nut sleeves follows along the slot with in the hollow portion of 35 upper steering shaft pivot until exposing the open threads in 35 upper steering shaft pivot through the lower hole on the forward facing side of 22 lower steering tube. 38 binding tee bolt is then installed thru said lower hole in 22 steering shaft and into a threaded portion of 35 upper steering shaft pivot. Threaded portion of 35 is best described at installation location of 38 FIG. 7. Installation is best depicted on FIG. 2. Tightening of 38 binding tee bolt into 35 upper steering shaft pivot induces a binding effect within the 22 lower steering shaft an the pivot joint producing a very solid structure. The secondary tightening of 37 lock sleeve tee bolt enhances the binding action within the joint.

27 complete front suspension, best depicted in FIG. 5, is mounted within 40 steering bearing assembly (commonly used on bicycles) within 39 outer steering tube best depicted in FIG. 8. This allows for the rotation needed for steering the mechanism. Positioned above upper steering bearing 40, is 41 steering shaft retainer nut. 41 steering shaft retainer nut threads onto an upper portion of 28 pivoting steering shaft after it has been installed thru 39 outer steering tube and 40 steering bearing assembly. 53 bearing retainer collar is affixed to 28 and provides a means of positioning and mounting the lower bearings on the 28 pivoting steering shaft.

To further describe the front pivot suspension of the preferred embodiment of the present invention, attention should be given to 27 complete front suspension of FIGS. 2, 5 and 6. 27 complete front suspension employs two 26 front tire and wheel assemblies, which when in operation provides additional needed traction. 26 front tire and wheel assemblies are affixed to 31 front suspension pivot assembly by 30 front axle bolts of FIG. 6. 29 suspension springs are placed over locators 34 within 31 front suspension pivot assembly FIG. 6. Said locators engage the inside of the 29 springs preventing unwanted movement of the springs. Said springs are located on 28 pivoting steering shaft by 33 upper spring attachment brackets. 33 upper spring attachment bracket engage the inside of the upper most portion of 29 suspension springs preventing unwanted movement of the springs. 33 upper spring attachment brackets are affixed to 28 pivoting steering shaft.

28 pivoting steering shaft employs 54 pivot steering bearing sleeve. Said sleeve is affixed to the lower most portion of 28 pivoting steering shaft providing a permanent location for 32 front suspension pivot bolt to pivot freely within 54 of 28.
When assembled, 32 front suspension bolt passes thru a smooth hole protrusion located on 31 front suspension pivot assembly, then passing thru a thrust washer (not shown) into 54 pivoting steering bearing sleeve, entering a threaded protruded portion on the opposite side of 31 (not shown) which completes 27 front suspension assembly. This provides a flexible, durable front suspension.

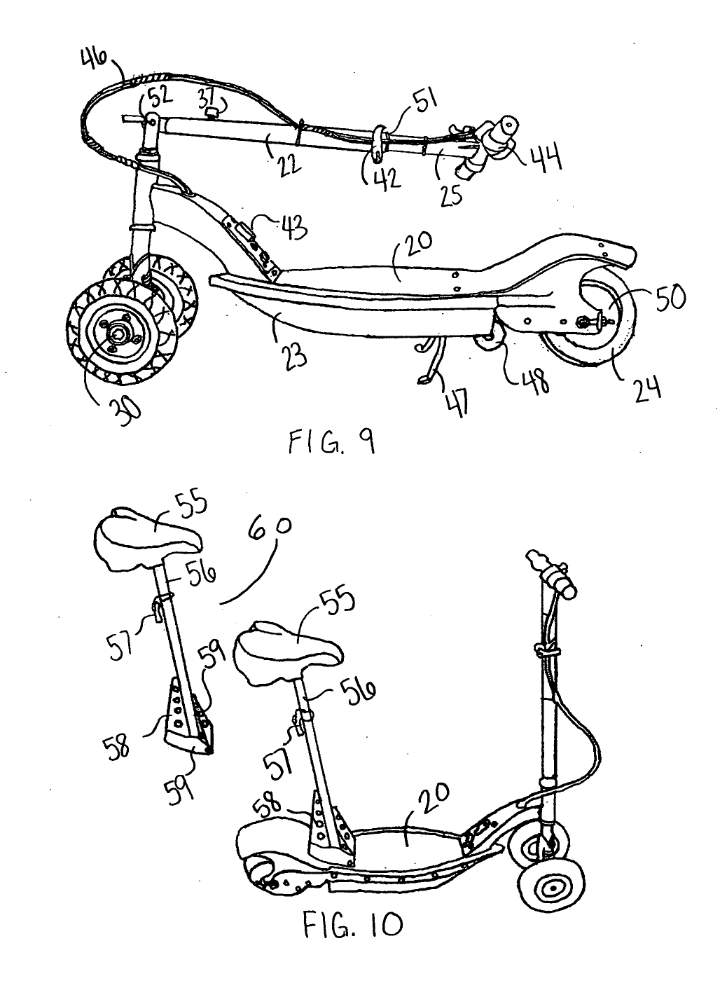

A quick attachment seat assembly 60 of FIG. 10 comprising of 58 quick attachment seat post, 57 seat post adjusting clamp, 56 height adjusting seat post and 55 transport seat, can be mounted to the scooter with thread fasteners or other quick attachment style fasteners. This enables the operator to operate the scooter from a seated position.

The following is a list of parts best suited to construct the present invention:

| Part number | Description |
|---|---|
| 20 | Floor Deck |
| 21 | Main Frame Neck |
| 22 | Lower Steering Tube |
| 23 | Bottom Cover |
| 24 | Rear Driving Wheel |
| 25 | Upper Tee Steering Tube |
| 26 | Front Tire and Wheel Assembly |
| 27 | Complete Front Suspension |
| 28 | Pivoting Steering Shaft |
| 29 | Suspension Springs |
| 30 | Front Axle bolts |
| 31 | Front Suspension Pivot Assembly |
| 32 | Front Suspension Pivot Bolt |
| 33 | Upper Spring Attachment Bracket |
| 34 | Lower Spring Locators |
| 35 | Upper Steering Shaft Pivot |
| 36 | Sliding Lock Nut Sleeve |
| 37 | Lock Sleeve Tee Bolt |
| 38 | Binding Tee Bolt |
| 39 | Outer Steering Tube |
| 40 | Steering Bearing Assembly |
| 41 | Steering Shaft Retainer Nut |
| 42 | Steering Tube Adjusting Clamp |
| 43 | Switch Panel |
| 44 | Twist Throttle Assembly |
| 45 | Brake Leaver Assembly |
| 46 | Brake and Throttle Cable Harness |
| 47 | Center Stand |
| 48 | Electric Motor |
| 49 | Handle Grip |
| 50 | Brake Band Assembly |
| 51 | Lower Steering Bushing |
| 52 | Pivot Pen |
| 53 | Bearing retainer collar |
| 54 | Pivot steering bearing sleeve |
| 55 | Transport seat |
| 56 | Height adjusting seat post |
| 57 | Seat post adjusting clamp |
| 58 | Quick attachment seat post |
| 59 | Quick attachment hardware |
| 60 | Quick attachment seat assembly |

What I claim is:

1. A three wheeled scooter for stand up operation or optional seated operation comprising of a frame and a pivotally mounted front suspension which employs two front wheels mounted parallel to each other and a single rear wheel.
a. A two wheeled independent front suspension. Said suspension is comprised of two front wheel assemblies with axle bolts, a pivoting steering shaft, a front suspension pivot assembly, suspension springs and a front suspension pivot bolt.
b. A suspension of above description without springs

2. A three wheeled scooter of claim 1 powered by a gas engine, electric motor or manual thrust.

3. A scooter of claim 1 employing a quick attachment height adjustable seat.

4. A three wheeled scooter of claim 1 for stand up or sit-down operation, with a foldable handlebar for storage.
a. Foldable steering tee handle being designed of oval shape.
b. Foldable handle pivot comprising of an upper pivot portion and a lower pivot portion affixed to a lower steering shaft. An adjustable length steering handle which is first lifted into an operational position and then slid downward covering the pivot joint, then tightened in place to form a structurally solid joint.

5. A three wheeled scooter of claim 1 further comprising of an electrically interfaced center stand for upright storage.
